(19) United States
(12) Patent Application Publication
(10) Pub. No.: US 2009/0055845 A1
(43) Pub. Date: Feb. 26, 2009

(54) Disc drive

(76) Inventors: Teruyuki Naka, Osaka (JP); Shinichi Maeda, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/892,465

(22) Filed: Aug. 23, 2007

(51) Int. Cl. G11B 17/03

(52) U.S. Cl. 720/600

(57) ABSTRACT

There is provided a disc drive including: a turntable that rotatably supports a disc; a drive motor that rotationally drives the turntable; a chassis that accommodates the drive motor and the turntable; a clamper that secures the disc to the turntable; and a cover body that holds the clamper and covers an upper part of the chassis. An inlet located in the proximity of an outer periphery portion of the disc, an outlet located above and at the center of the disc, and an air current path that allows the outlet to communicate with the inlet are formed in the cover body.

### BACKGROUND OF THE INVENTION

The present invention relates to a disc drive, and more particularly, to a disc drive that can adapt to higher speed, stable recording and/or reproduction of an information signal.

In recent years, in optical discs used as information recording media for video, music, or computer data, for example, due to a further increase in recording capacity, there is a demand for higher speed, stable recording and/or reproduction of information signals. Note that as used herein, the term “recording and/or reproduction (on a disc)” means “at least one of recording (of information on a disc) and reproduction (of information recorded on a disc)” and simplistically represents such meanings.

When a disc is rotated at high speed in a disc drive, a pressure difference occurs due to the air current generation state being different between the bottom and top sides of the disc. Due to the pressure difference, microscopic deformation occurs in the disc. It is known that the deformation is particularly large at a specific rotation frequency at which disc resonance occurs, and adversely affects the recording characteristics and/or reproduction characteristics of information signals.

FIG. 1 is a cross-sectional view schematically showing the main part of an internal structure of a conventional disc drive 101. As shown in the figure, in a chassis 102 (so-called “mechanical chassis”) that accommodates main internal components of the disc drive 101, a drive motor 103 that rotationally drives a turntable 104 that rotatably supports a disc D is disposed. A cover body 110 (so-called “upper base”) that holds a clamper 111 that secures the disc D to the turntable 104 covers the upper part of the mechanical chassis 102. A cover plate 113 (clamp cover) covers the upper part of the clamper 111. Note that the disc drive 101 is used in a state where it is housed in a metal casing (not shown), for example, substantially hermetically.

In the mechanical chassis 102, an optical pickup (not shown) is disposed at a side of the drive motor 103 and a pickup space portion is provided to accommodate the optical pickup and allow the optical pickup to reciprocate between the inner and outer peripheries of the disc D. In addition, a tray space portion is provided to allow a disc tray (not shown) on which the disc D is placed, to reciprocate between the inside and outside of the disc drive 101. The pickup space portion and the tray space portion extend in a direction substantially perpendicular to the paper plane, for example.

In the above configuration, when the disc D is rotated, as schematically shown in FIGS. 2A and 2B, by centrifugal action caused by the rotation of the disc D, air currents Ka and Kb flowing substantially along the disc surface from the center toward the outer periphery are generated on the top side (see FIG. 2A) and the bottom side (see FIG. 2B) of the disc D. In FIGS. 2A and 2B, outlined arrows Ra and Rb each indicate the rotation direction of the disc D, the directions of dashed-double-dotted arrows indicate the directions of the air currents Ka and Kb, and large/small numbers of the dashed-double-dotted arrows indicate large/small amounts of the air currents.

Since the bottom side of the disc D faces the inside of the mechanical chassis 102 and the pickup space portion and the tray space portion are provided inside the mechanical chassis 102, air is relatively easily supplied to the bottom side of the disc D through the space portions. On the other hand, the area above the disc D is covered by the upper base 110 and the clamp cover 113 and no particular supply path for supplying air to the top side of the disc D is provided. Accordingly, the amount of air supply to the top side of the disc D is far smaller than that to the bottom side.

Therefore, as shown in FIGS. 2A and 2B, there is a large difference in the amount of air current to be generated between the top and bottom sides of the disc D and depending on the difference in the amount of air current, a pressure difference occurs. Generally, the larger the centrifugal action caused by the rotation of the disc is with a high rotation speed of the disc D, the greater the pressure difference becomes. Due to this pressure difference, deformation occurs in the disc. The deformation is remarkably large at a specific rotation frequency at which disc resonance occurs, which adversely affects the recording and/or reproduction characteristics of information signals.

For example, in the case of a 12 cm-diameter optical disc, it is known that the disc rotation frequency at which resonance occurs are about 6800 rpm, about 8000 rpm, and about 9500 rpm and the disc resonance mode varies depending on such rotation frequency.

FIGS. 3A to 3C and 4A to 4C are schematic illustrative diagrams clearly and exaggeratedly showing results of estimation of disc deformation states in various resonance modes based on simulations. FIGS. 3A to 3C are perspective views of a disc and FIGS. 4A to 4C are plan views of the disc.

As shown in these figures, when the disc rotation frequency is about 6800 rpm, the disc exhibits a resonance mode of a so-called outer periphery 4-split mode (276 Hz), and when the disc rotation frequency is about 8000 rpm, the disc exhibits a resonance mode of a so-called outer periphery 6-split mode (416 Hz). When the disc rotation frequency is about 9500 rpm, the disc exhibits a resonance mode of a so-called outer periphery 8-split mode (619 Hz).

FIG. 5 is a graph showing a relationship between the disc rotation frequency and a change in tilt characteristics (i.e., the tilt angle of a disc surface) due to deformation of the disc. In FIG. 5, a solid curve indicates a change in tilt in a circumferential direction and a dashed curve indicates a change in tilt in a radial direction. As can be clearly seen from the figure, at the rotation frequency at which resonance occurs, a change in tilt, particularly a change in tilt in the circumferential direction, is very large, which gives a great influence on the recording and/or reproduction characteristics of information signals.

In relation to the above-described problems of disc deformation caused by a pressure difference resulting from a difference in air current generation state between the top and bottom sides of a disc and of disc resonance, Japanese Patent Laid-Open Publication No. 2001-176260, for example, discloses a disc drive in which a plurality of projections projecting toward the inner side of the disc drive are provided on an inner wall, opposite to the disc, of a cover body covering the upper part of a mechanical chassis (i.e., above a disc). This conventional disc drive is intended to suppress oscillation of a disc by providing the projections on the inner wall of the cover body to adjust an air current on the top side of the disc.

In such a configuration, however, since the projections projecting toward the inner side of the disc drive are provided on the inner wall of the cover body, the height of the cover body inevitably is increased and the size of the disc drive is increased accordingly. In addition, there is a problem that it is practically very difficult to optimally set the number, size, shape, locations, and the like of the projections so that the pressure difference between the top and bottom sides of the disc can be surely reduced by suitably adjusting the air current on the top side of the disc.

### SUMMARY OF THE INVENTION

The present invention was made in view of the foregoing technical problems. A basic object of the present invention is to enable to surely reduce a pressure difference between the top and bottom sides of a disc by surely increasing the amount of air supply to the top side of the disc when the disc is rotated, without increasing the size of a disc drive.

Therefore, a disc drive according to the present invention includes: a turntable that rotatably supports a disc; a drive motor that rotationally drives the turntable; a chassis that accommodates the drive motor and the turntable; a clamper that secures the disc to the turntable; and a cover body that holds the clamper and covers an upper part of the chassis, wherein an inlet located in the proximity of an outer periphery portion of the disc, an outlet located above and at the center of the disc, and an air current path that allows the outlet to communicate with the inlet are formed in the cover body.

By adopting such a configuration, when a disc is rotated, air is surely supplied from the proximity of the outer periphery portion of the disc to an area above and at the center of the disc through the air current path. That is, the amount of air supply to the top side of the disc surely increases and thus the pressure difference between the top and bottom sides of the disc surely decreases.

In this case, it is preferable that the outlet opens to a clamper accommodating space portion for accommodating the clamper.

With the outlet of the air current path opening to the clamper accommodating space portion, air can be discharged and supplied to the area above and at the center of the disc with a simple configuration.

In the above case, it is preferable that a dust collecting mechanism be provided in the air current path. For the dust collecting mechanism, a normal dust filter can be used; in addition to this, in order, for example, to further reduce passage resistance, a raising structure formed by implanting artificial fibers on a wall of the path, a porous material arranged on part of the path, or the like can be applied.

By providing the dust collecting mechanism in the air current path, air that circulates through the disc drive is cleaned by utilizing the air current path.

### BRIEF DESCRIPTION OF THE DRAWINGS

The present invention will be described in detail with reference to the accompanying drawings.

FIG. 1 is a cross-sectional view showing the main part of a conventional disc drive;

FIG. 2A is a plan view of a disc showing an air current generation state of the top side of the disc in the conventional disc drive;

FIG. 2B is a bottom view of the disc showing an air current generation state of the bottom side of the disc in the conventional disc drive;

FIGS. 3A, 3B, and 3C are schematic perspective views for describing disc deformation states in the conventional disc drive when the rotation frequencies are 6800 rpm, 8000 rpm, and 9500 rpm;

FIGS. 4A, 4B, and 4C are schematic plan views for describing disc deformation states in the conventional disc drive when the rotation frequencies are 6800 rpm, 8000 rpm, and 9500 rpm;

FIG. 5 is a graph showing a relationship between the disc rotation frequency and a change in tilt characteristics due to deformation of the disc in the conventional disc drive;

FIG. 6 is a graph showing a relationship between the disc rotation frequency and a change in tilt characteristics due to deformation of the disc in a disc drive according to an embodiment of the present invention;

FIG. 7 is an overall perspective view of the disc drive according to the embodiment of the present invention;

FIG. 8 is an exploded perspective view of a cover body of the disc drive according to the embodiment of the present invention;

FIG. 9 is a cross-sectional view showing the main part of the disc drive according to the embodiment of the present invention and is a partial cross-sectional view taken along line Y9-Y9 of FIG. 7;

FIG. 10 is a cross-sectional view of an air current path for describing a dust collecting mechanism provided in the air current path of the disc drive according to the embodiment of the present invention and is a partial cross-sectional view taken along line Y10-Y10 of FIG. 7;

FIG. 11 is a partial cross-sectional view of an air current path for describing a first variation of the dust collecting mechanism;

FIG. 12 is a plan view of an air current path for describing a second variation of the dust collecting mechanism; and

FIG. 13 is a plan view of an air current path for describing a third variation of the dust collecting mechanism.

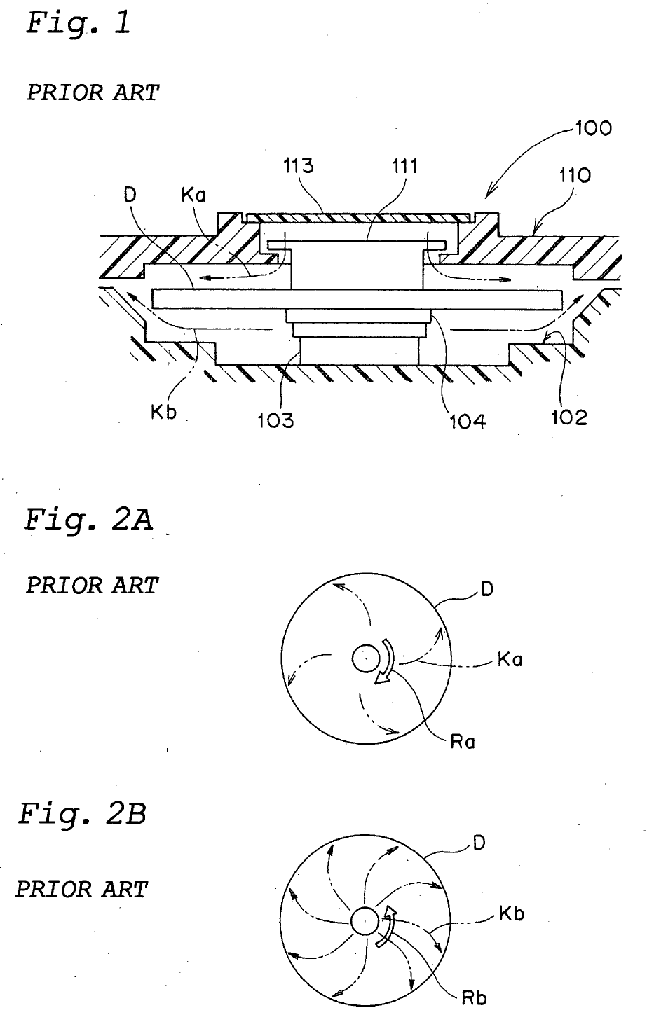

### DETAILED DESCRIPTION OF THE PREFERRED EMBODIMENTS

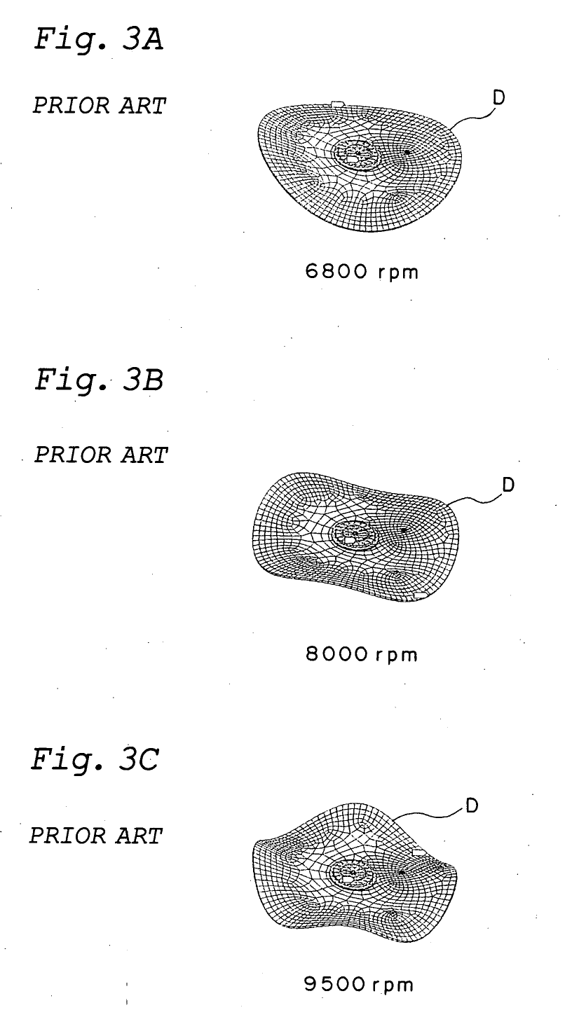

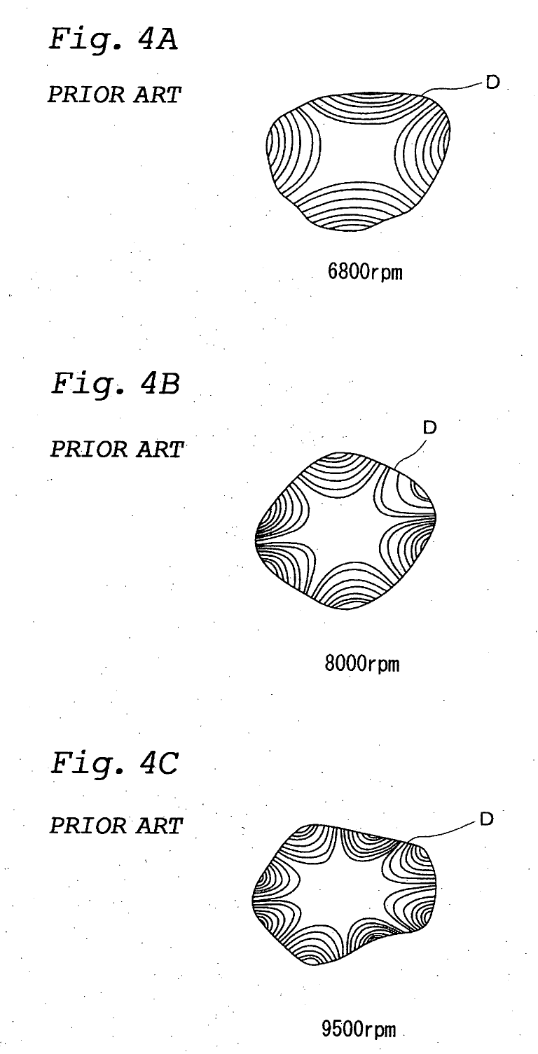

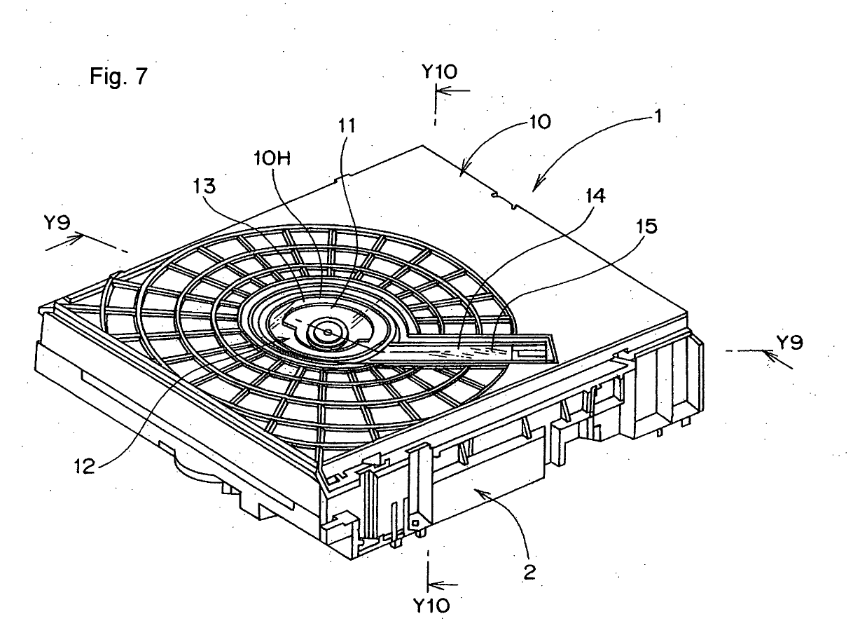

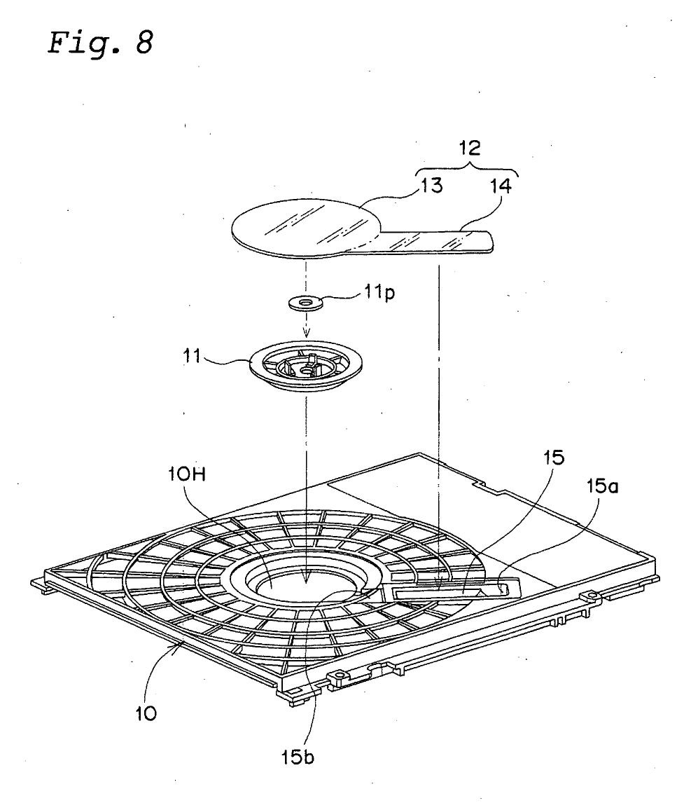

FIG. 7 is a perspective view of a disc drive schematically showing the overall configuration of a disc drive according to an embodiment of the present invention, and FIG. 8 is an exploded perspective view of a cover body schematically showing a configuration of the cover body of the disc drive. FIG. 3 is a cross-sectional view showing the main part of the disc drive and is a partial cross-sectional view taken along line Y9-Y9 of FIG. 7.

As shown in these figures, in a disc drive 1 according to the present embodiment, main internal components are all accommodated in a chassis 2 (so-called “mechanical chassis”). The upper part of the mechanical chassis 2 is covered by a cover body 10 (so-called “upper base”). Note that the upper base 10 and the mechanical chassis 2 are preferably formed using a synthetic resin as a material.

The disc drive 1 in which necessary internal components are incorporated in the mechanical chassis 2 and the upper part of the mechanical chassis 2 is covered by the upper base 10 is used in the state where it is housed in, for example, a metal casing (not shown) substantially hermetically.

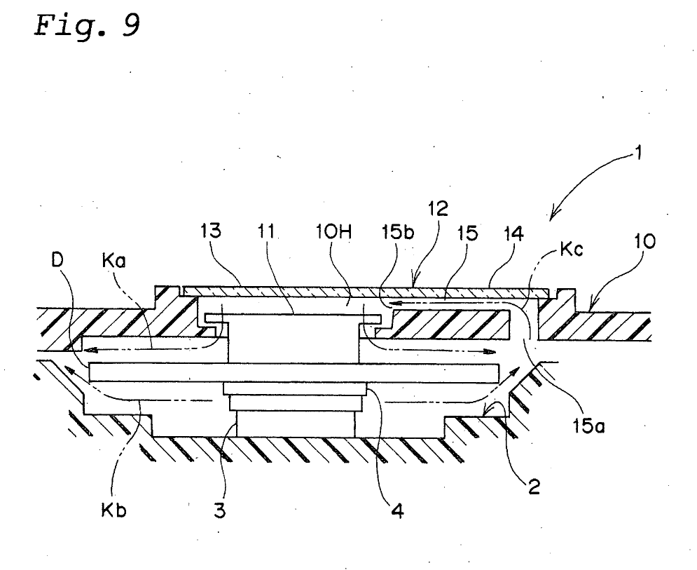

As shown in FIG. 9, in the mechanical chassis 2, a turntable 4 that rotatably supports a disc D and a drive motor 3 that rotationally drives the turntable are disposed. Above the turntable 4 is located a clamper 11 that secures the disc D on the turntable 4 when the disc D is loaded in the disc drive 1.

The clamper 11 includes, at its center, a ring-shaped yoke plate lip and is rotatably held in a clamper space portion 10H of the upper base 10. Note that, although not specifically shown, a back yoke and a magnet that cooperate with the yoke plate 12 so that the disc D can be sandwiched and held between the turntable 4 and the clamper 11 are included in the center portion of the turntable 4. Such clamp/unclamp mechanism for the disc D, holding structure of the clamper 11 by the upper base 10, and the like are the same as those conventionally known and thus the detailed diagrammatic representation and explanation thereof are omitted.

In the mechanical chassis 2, an optical pickup (not shown) for recording an information signal on the disc D and/or reproducing an information signal recorded on the disc D is disposed at a side of the drive motor 3, and a pickup space portion is provided to accommodate the optical pickup and allow the optical pickup to reciprocate between the inner and outer peripheries of the disc. In addition, a tray space portion is provided to allow a disc tray (not shown) on which the disc D is placed, to reciprocate between the inside and outside of the disc drive 1. The pickup space portion and the tray space portion extend in a direction substantially perpendicular to the paper plane, for example. Note that the tray space portion and the pickup space portion can also be configured as one space portion.

The bottom side of the disc D sandwiched and held between the turntable 4 and the clamper 11 faces the inside of the mechanical chassis 2. In the mechanical chassis 2, as described above, the pickup space portion (not shown) and the tray space portion (not shown) are provided. Therefore, when the disc D is rotated, air is relatively easily supplied to the bottom side of the disc D through the space portions.

In the present embodiment, an air current path 15 is provided in the upper base 10 in order to reduce a pressure difference between the top and bottom sides of the disc D by increasing the amount of air supply to the top side of the disc D.

The air current path 15 is configured such that a groove extending in a substantially radial direction from the clamper space portion 10H is formed in a top side of the upper base 10 and the upper part of the groove is covered by a flat plate (a path cover portion 14 of a cover plate 12) which extends in a substantially rectangular shape. The clamper space portion 10H accommodating the clamper 11 is located above and at the center of the disc D, and as can be seen from FIG. 9, one end of the air current path 15 is connected to an opening 15b (outlet) to the clamper space portion 10H. In addition, an opening 15a (inlet) is provided in a portion of the upper base 10 corresponding to the proximity of a disc outer periphery portion and the other end of the air current path 15 is connected to the inlet 15a.

Specifically, the air current path 15 allows the inlet 15a located in the proximity of the outer periphery portion of the disc D to communicate with the outlet 15b opening to the clamper space portion 10H and located above and at the center of the disc D. Note that the upper part of the clamper space portion 10H is covered by a circular portion (clamp cover portion 13) of the cover plate 12. The path cover portion 14 is configured to extend substantially along, for example, a tangential direction from an outer periphery of the circular clamp cover portion 13. The clamp cover portion 13 and the path cover portion 14 may be provided separately; however, in the present embodiment, in view of a reduction in manufacturing cost by reducing the number of components, the clamp cover portion 13 and the path cover portion 14 are integrally formed as a single cover plate 12.

The cover plate 12 is made of a synthetic resin, for example, and is fixed to the upper base 10 in an air-tightly sealed state. The cover plate 12 may be removably fixed to the upper base 10 or may be bonded and fixed to the upper base 10 using an adhesive, for example. Note that in the present embodiment, the cover plate 12 is preferably formed of a transparent resin plate.

In the above configuration, when the disc D is rotated, by the centrifugal action caused by the rotation of the disc D, air currents Ka and Kb flowing substantially along the disc surface from the center toward the outer periphery are generated on the top and bottom sides of the disc D. At this time, in conventional cases, as shown in FIGS. 2A and 2B, a large difference occurs in the amount of generated air current between the top side (see FIG. 2A) and the bottom side (see FIG. 2B) of the disc D, and due to the difference in the amount of air current, a pressure difference occurs.

In the present embodiment, however, since the air current path 15 is provided, when the disc is rotated, air is taken in from the proximity of the outer periphery portion of the disc D through the inlet 15a, and the air is lead to the clamper space portion 10H through the air current path 15 (air current Kc) and surely supplied from the outlet 15b to an area above and at the center of the disc D. That is, the amount of air supply to the top side of the disc D surely increases and the difference in the amount of the generated air current between the top and bottom sides of the disc D becomes smaller, so that the pressure difference surely decreases.

Accordingly, even when the disc rotation frequency is increased and centrifugal action caused by the rotation of the disc becomes large, it is possible to suppress occurrence of deformation in the disc due to the pressure difference between the top and bottom sides of the disc D. Particularly, even at specific rotation frequency at which disc resonance occurs, the influence given on the recording and/or reproduction characteristics of information signals can be reduced.

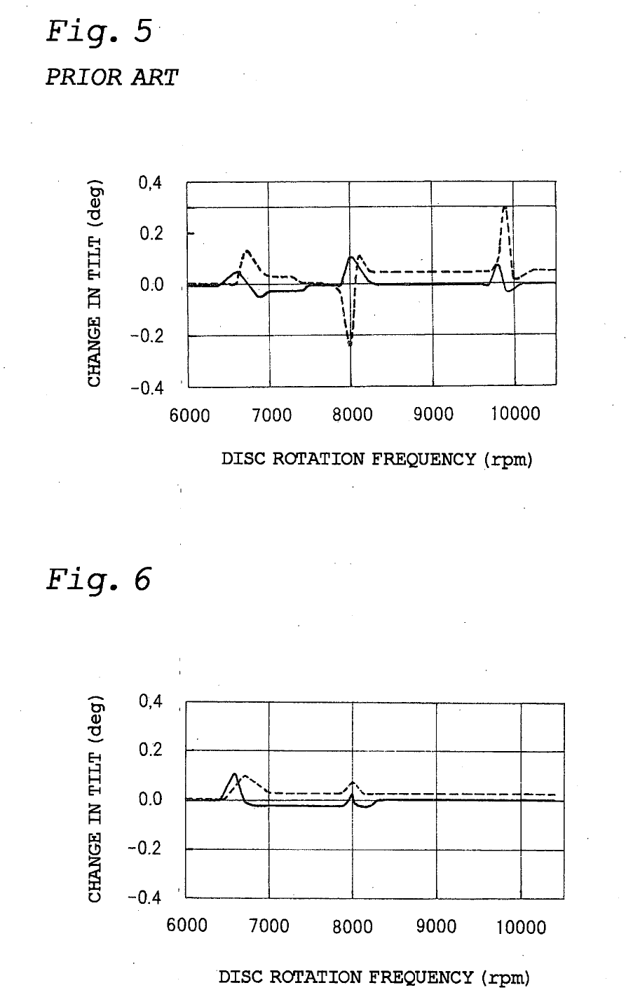

FIG. 6 is a graph showing a relationship between the disc rotation frequency and a change in tilt characteristics (i.e., the tilt angle of a disc surface) due to deformation of the disc D in the disc drive 1 according to the present embodiment. In FIG. 6, a solid curve indicates a change in tilt in a circumferential direction and a dashed curve indicates a change in tilt in a radial direction. As can be clearly seen by comparing FIG. 6 and FIG. 5 for the conventional example, in the disc drive 1 according to the present embodiment, at the rotation frequency at which resonance occurs, a change in tilt, particularly a change in tilt in the circumferential direction which is very large in the conventional example, is significantly reduced and thus an effect of the present invention is verified.

In this case, the air current path 15 can be provided with a simple configuration in which a groove is formed in the top side of the upper base 10 and the groove is covered by the path cover portion 14 of the cover plate 12. That is, the air current path 15 can be provided at a low cost. In addition, unlike the conventional case, there is no increase in the size of the disc drive as a result of an increase in the height of the cover body (upper base).

In the present embodiment, since particularly the outlet 15b of the air current path 15 opens to the clamper space portion 10H accommodating the clamper 11, air can be discharged and supplied to the area above and at the center of the disc D with a simpler configuration.

As described above, the disc drive 1 is used in the state where it is housed in a metal casing (not shown), for example, substantially hermetically. Thus, air currents generated on the top and bottom sides of the disc D by the rotation of the disc D circulate through the casing which is in a substantially hermetic state. It is important to keep the air circulating through the disc drive 1 clean in terms of maintaining the high-accuracy recording and/or reproduction performance of the disc drive 1.

In view of this, in the present embodiment, by using the air current path 15, dust contained in the air that circulates through the disc drive 1 is removed to clean the air.

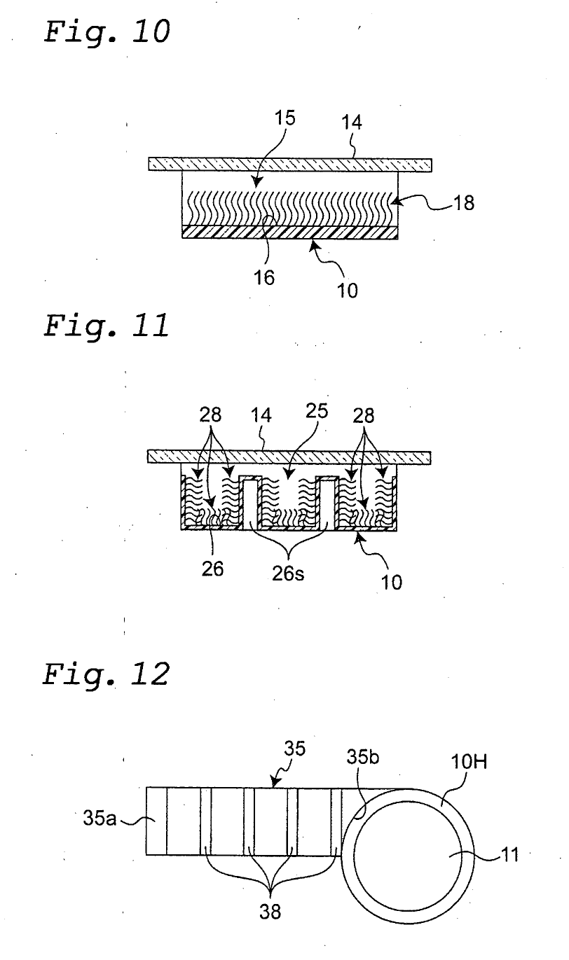

FIG. 10 is a cross-sectional view of the air current path 15 for describing a dust collecting mechanism provided in the air current path 15 of the disc drive 1 and is a partial cross-sectional view taken along line Y10-Y10 of FIG. 7. As shown in the figure, a raising structure with a predetermined height is formed on a bottom surface 16 of the air current path 15 (i.e., part of a region of the upper base 10 corresponding to the air current path 15) by implanting a multitude of artificial fibers. The raising structure constitutes a dust collecting mechanism 18 that collects dust contained in the air current Kc passing through the air current path 15.

For the artificial fibers used to form the dust collecting mechanism 18 (i.e., the raising structure), artificial fibers with high commercial availability such as acrylic, nylon, polyester, and rayon can be used.

In this case, the height of the dust collecting mechanism 18 is limited to the predetermined height, and thus the dust collecting mechanism 18 does not cover the entire cross section of the air current path 15. Moreover, the dust collecting mechanism 18 is formed by implanting artificial fibers on the bottom surface 16 of the path, and thus has very high flexibility to the passage of the air current Kc. Accordingly, an increase in passage resistance due to providing the dust collecting mechanism 18 in the air current path 15 can be very effectively reduced.

In the case where the dust collecting mechanism 18 is provided in the air current path 15 in this manner, in order to ensure maintainability of the dust collecting mechanism 18, it is preferable that the path cover portion 14 covering the upper part of the air current path 15 (accordingly, the cover plate 12) be removable with respect to the air current path 15.

A variation of such a dust collecting mechanism will be described below.

FIG. 11 is a partial cross-sectional view of an air current path for describing a first variation of the dust collecting mechanism provided in the air current path. In an air current path 25 according to the first variation, divider portions 26s in a vertical direction that divide the air current path 25 into a plurality of flow channels are formed on a bottom surface 26 of the air current path 25. Then, raising structures 28 (dust collecting mechanism) with a predetermined height are formed on the bottom surface 26 and surfaces of the divider portions 26s by implanting a multitude of artificial fibers.

In the case of the dust collecting mechanism 25 according to the first variation, an artificial-fiber-implanted area can be increased more as compared with the dust collecting mechanism 15 in FIG. 10, and thus, improvement in dust collection efficiency can be achieved with the same passage area.

FIG. 12 is a plan view of an air current path for describing a second variation of the dust collecting mechanism provided in the air current path. In the second variation, a dust collecting mechanism is constituted by vertical filters 38 covering the entire cross section of an air current path 35. For the filters 38, a filter formed by weaving the aforementioned artificial fibers into a cloth can be used and a plurality of (four in the present variation) filters 38 are provided between an inlet 35a and an outlet 35b to the clamper space portion 10H.

In this case, although the passage resistance increases to some extent as compared with the examples of FIGS. 10 and 11, by providing the filters 38 covering the entire cross section of the air current path 35, a very high dust collecting effect can be obtained.

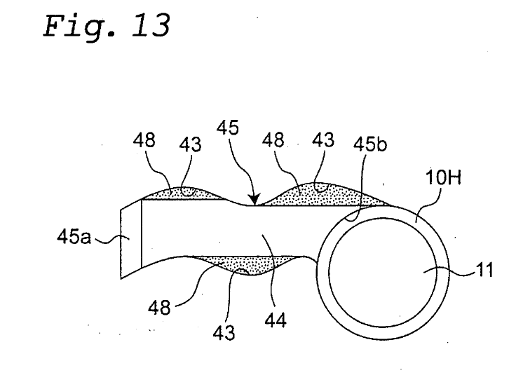

FIG. 13 is a plan view of an air current path for describing a third variation of the dust collecting mechanism provided in the air current path. In the third variation, an air current path 45 is formed so as to be serpentine, as viewed from the top, between an inlet 45a and an outlet 45b. Then, a dust collecting mechanism 48 is provided in bending path portions 43 (bending path) except in a path portion 44 (straight path) which extends straight from the inlet 45a to the outlet 45b. For the dust collecting mechanism 48, a porous material composed of activated carbon, for example, can be used. Alternatively, the aforementioned raising structure may be used.

In this case, since only the air passing through the bending path 43 is subjected to passage resistance, the passage resistance can be significantly reduced.

Note that although in the above examples, for a dust collecting mechanism, a raising structure formed by implanting artificial fibers, a filter in a cloth form formed by weaving artificial fibers, or a porous material composed of activated carbon or the like is used, the dust collecting mechanism is not limited thereto, and other various configurations can be used, such as one in which a wet absorbing film is applied to an inner wall surface of the air current path.

The present invention is not limited to the above-described embodiment and variations thereof, and various modifications and changes may be made without departing from the spirit and scope of the invention.

1. A disc drive comprising:
a turntable that rotatably supports a disc;
a drive motor that rotationally drives the turntable;
a chassis that accommodates the drive motor and the turntable;
a clamper that secures the disc to the turntable; and
a cover body that holds the clamper and covers an upper part of the chassis, wherein
an inlet located in the proximity of an outer periphery portion of the disc, an outlet located above and at the center of the disc, and an air current path that allows the outlet to communicate with the inlet are formed in the cover body.

2. The disc drive according to claim 1, wherein the outlet opens to a clamper accommodating space portion that accommodates the clamper.

3. The disc drive according to claim 1, wherein a dust collecting mechanism is provided in the air current path.

4. The disc drive according to claim 2, wherein a dust collecting mechanism is provided in the air current path.
